(19) United States
(12) Patent Application Publication
(10) Pub. No.: US 2011/0259152 A1
(43) Pub. Date: Oct. 27, 2011

(54) METHOD AND APPARATUS FOR REMOVING LIDS FROM MEDICAL SHARPS OR WASTE CONTAINERS

(75) Inventor: Michael S. Kovacs, Sammamish, WA (US)

(73) Assignee: ClearMedical, Inc., Bellevue, WA (US)

(21) Appl. No.: 12/766,448

(22) Filed: Apr. 23, 2010

(51) Int. Cl. B67B 7/14

(52) U.S. Cl. 81/3.36

(57) ABSTRACT

Apparatus are disclosed for removing a cover from a disposable sharps container. For example, a quadrilateral frame with ends and sides that slide into corner sections can be adjusted using force actuators to change the length and width of the frame, so as to apply an inwardly directed force on the container that disengages a lip of the container from an edge of the cover. Similarly, a plurality of force actuators coupled by shafts to force applicators can apply an inwardly directed force to disengage the cover from the container. In an alternative approach, claws on levers can apply a force to disengage the edge of the cover from the lip, when actuated by a prime mover or a hydraulic/pneumatic cylinder. Medical waste in the container can be dumped and sorted to recover reusable devices. The cover and container can be cleaned, sterilized, and reused.

### BACKGROUND

Medical waste is collected at healthcare facilities using various types of containers, depending on the type of medical waste being discarded. Soft waste, such as contaminated towels and bandages removed from patients, may be placed in bright red biohazard bags and is thus appropriately called “red bag waste.” Rigid medical devices or hardware that has been used on a patient, such as scissors, graspers, shavers, blades, clip appliers, needles, and trocars, are collected in solid-sided containers referred to as “sharps containers.” Sharps containers are also used to collect pharmaceutical waste, broken glass, and vials containing liquids. These sharps containers come in many different sizes and styles and are typically provided at several locations inside a healthcare facility, such as in treatment rooms, examination rooms, and operating rooms.

One of the primary functions of sharps containers is to provide a safe repository for potentially harmful or dangerous apparatus. For example, used needles and surgical instruments that are not normally intended for cleaning, sterilization, and reuse are simply inserted into a sharps container, so that they need not be further handled in an unprotected state. The sharps containers enclose such devices so that they cannot accidentally harm medical personnel or patients. In addition, because devices used in connection with testing, administering drugs, or providing medical treatment to a patient are often exposed to a patient's bodily fluids, there is always a potential for such devices to infect another person with whom they come into contact. For example, a needle used on a syringe to administer a drug to a patient or withdraw blood can be exposed to disease carried by that patient. By disposing of the needle or other such hardware devices in a sharps container, personnel and other patients are prevented from being accidently punctured, or cut, and thus exposed to infection by the disease pathogens.

Sharps containers can be categorized into two groups. The first group is intended to be reusable, while the second group is intended to be disposable, and only expected to be single-use. Reusable containers are designed in such a way that the cover on the sharps container is intended to be easily removed. After the contents have been emptied from this type of sharps container, the container and lid are expected to be cleaned, sterilized, and returned for further use as a sharps container. In contrast, disposable sharps containers are designed so that once the lid is attached, it is not to be removed. Since disposable sharps containers are not normally expected to be opened to retrieve the contents, they are typically provided with covers that engage the container top edge of the container body and once thus installed, are not readily removed from the container body.

Many sharps containers include sliding panels or doors on the cover that are opened to enable dropping used medical apparatus or hardware into the container, and then closed to limit further access until more objects are to be deposited therein. It is not intended that any object or material that has been inserted into the sharps container be removed through these apertures. Instead, disposable sharps containers are commonly collected when full and are then shipped to disposal facilities that are equipped to safely dispose of the container and its contents, e.g., by incineration of the unopened sharps container with its contents inside.

Recently, it has been recognized that medical personnel commonly dispose of potentially reusable medical apparatus, such as trocars, by dropping them into sharps containers. Special apparatus and techniques for handling sharps containers that have been collected from medical facilities have been developed to recover such potentially reusable medical devices to enable them to be safely recycled and reused. In this process, the contents of sharps containers are emptied onto a sorting surface, and the reusable devices are selected and retrieved for cleaning, and sterilization. The remaining medical waste materials and devices are then properly disposed of by incineration or other appropriate techniques. Details of exemplary embodiments of systems and apparatus, and for the methods for carrying out these functions are disclosed in commonly assigned U.S. Pat. Nos. 7,591,380 and 7,677,395, the specification and drawings of which are hereby specifically incorporated herein by reference.

It will be apparent that before reusable medical devices can be selected from the contents of sharps containers, it is first necessary to remove the cover from each sharps container and dump the contents onto a sorting surface. However, since the covers of disposable sharps container are not designed to be removed, this task requires some considerable effort if done manually and slows the entire process. Also, if disposable sharps containers are instead to be cleaned, sterilized, and reused, it is important that the covers be removed without damaging either the containers or the covers. Accordingly, it would be desirable to automate the task of removing the covers from disposable sharps containers and then dumping the contents onto a sorting surface. The process should be carried out quickly and efficiently. Since sharps containers are sold in many different shapes and sizes, within at least a limited range, the automated process should be capable of removing the covers from sharps containers of differing size and shape, and then handling the container body to dump the contents onto a sorting surface.

### SUMMARY

Exemplary apparatus are disclosed herein for use in removing a cover from a medical waste sharps container, to access the contents of the sharps container. The apparatus includes means for disengaging an edge on the cover from a lip on the sharps container and removing the cover from the sharps container to expose the contents of the sharps container. Means are also included for handling the sharps container to access its contents. The means for disengaging the edge on the cover can comprise a plurality of force actuators disposed to selectively apply an inwardly directed force against the surface of the sharps container, at opposite sides of the sharps container and at positions that are adjacent to the lip on the sharps container. The force displaces the lip inwardly so that it disengages from the edge of the cover, thereby releasing the cover from the sharps container.

The means for disengaging the edge on the cover can also comprise a variable dimension frame that encompasses the sharps container. The variable dimension frame can include two sides, each side having a variable length; and, two ends coupled to the two sides, each end having a variable length. A plurality of force actuators apply force to the variable dimension frame to change the lengths of the sides and the ends of the variable dimension frame. A dimension of the variable dimension frame is changed by the plurality of force actuators, causing the sides and ends to apply force to the outer surface of the sharps container at positions adjacent to the lip on the sharps container. This force displaces the lip inwardly, disengaging the lip from the edge of the cover, and thereby releasing the cover from the sharps container.

As an alternative, the means for disengaging the edge on the cover can comprise a plurality of levers. Each lever has a claw for engaging a portion of the edge of the cover and applying force outwardly, disengaging the edge of the cover from the lip of the sharps container, and thereby releasing the cover from the sharps container.

As yet another alternative, the means for disengaging can further comprise at least one post that presses down on the cover while claws on the plurality of levers pull on the edge of the cover. In response, the cover deflects, and the edge of the cover is forced to disengage from the lip of the sharps container.

Further, the means for disengaging can comprise at least one force actuator mechanically coupled to the plurality of levers for producing the force that causes the claws on the plurality of levers to disengage the edge of the cover from the lip of the sharps container. The force actuator(s) can be a cylinder having a piston actuated to move within the cylinder with a pressurized fluid that is supplied to the cylinder, or a prime mover.

The means for handling the sharps container is operative to tilt the sharps container after the cover has been removed, and to dump the contents of the sharps container onto a sorting surface.

Another aspect of the present novel approach is directed to a method for removing the lid from a medical waste sharps container, to access the contents of the sharps container. This method generally includes steps that correspond to the functions implemented by the apparatus discussed above.

As already noted, this application specifically incorporates by reference the disclosures and drawings of each issued patent identified above.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is an isometric view of two sides of an exemplary disposable type sharps container and cover;

FIG. 2 is a cut away isometric view of top of the cover of the exemplary disposable sharps container of FIG. 1, showing the hospital primary access door on the cover open, to enable used medical hardware to be deposited in the sharps container without removing the cover, since the cover is normally not intended to be removed once attached to the sharps container;

FIG. 3 is a cut away isometric view of top of the cover of the exemplary disposable sharps container of FIG. 1, showing the hospital primary access door on the cover closed, which would be its state normally, for transport to a disposal center;

FIG. 4 is a partial view of an underside of an exemplary cover for a sharps container, illustrating the tabs that are provided to engage the lip of a sharps container so as to lock the cover in place on the sharps container;

FIG. 5 is a partial view of an inverted exemplary disposable sharps container, showing how the tabs on the cover of FIG. 4 engage the lip of the sharps container to retain the cover on the container body;

FIG. 6 is a partial view of the top of an exemplary cover for a disposable sharps container, showing an access door closed and placed in a final lock position, as is normally done when the sharps container is to be transported for disposal of the container and its contents, in contrast to a temporary lock position at which the access door is closed left between times that it is opened to enable used medical devices to be dropped into the disposable sharps container;

FIG. 7 is an exemplary label used on a disposable sharps container, which indicates that the sharps container is intended to be for a “single use” and not recycled after it has been filled;

FIG. 8 is a schematic isometric view of an exemplary embodiment of apparatus for handling sharps containers and removing their covers, which comprises a quadrilateral frame that has sliding components to enable the length and width of the quadrilateral frame to be varied by a pair of force actuators that are mechanically coupled to the frame;

FIG. 9A is a schematic isometric view of the exemplary embodiment of FIG. 8 as the frame is sized to encompass an exemplary disposable sharps container as the frame is slid over the container;

FIG. 9B is a schematic isometric view of the exemplary embodiment of FIGS. 8 and 9A, showing how the force actuators are energized to reduce the length and width of the frame by moving the sliding components so that the frame closes tightly against the outer surface of the exemplary sharps container;

FIG. 9C is a schematic isometric view of the exemplary embodiment of FIGS. 8, 9A, and 9B, showing the frame components pressing against the outer surface of the exemplary sharps container with sufficient force to disengage the lip of the sharps container from the edge of cover, popping the cover from the sharps container body;

FIG. 10 is a schematic isometric view of the exemplary sharps container of FIGS. 9A-9C, after the contents have been dumped onto a sorting surface (not shown), and the sharps container and its cover are now ready to be cleaned, sterilized, and reused;

FIG. 11A is a schematic view of another exemplary embodiment of apparatus for removing a cover from a sharps container, wherein a support structure for a plurality of force actuators used to apply force to a corresponding plurality of force applicators is shown in phantom view, along with the sharps container;

FIG. 11B illustrates the embodiment of FIG. 11A (but for simplicity, omits the phantom view of the supporting structure), showing how the force applicators have been advanced into contact with each of the four sides of the sharps container and have applied sufficient force to the sharps container to disengage the lip of the sharps container from the edge of the cover;

FIG. 11C illustrates the exemplary embodiment of FIGS. 11A and 11B being used for inverting the sharps container, to dump medical devices and other objects onto a sorting surface;

FIG. 12A illustrates a cross-sectional view of an exemplary cover and exemplary disposable sharps container before the cover is fastened onto the sharps container;

FIG. 12B illustrates a cross-sectional view of the exemplary cover and exemplary disposable sharps container of FIG. 12A, after the cover has been fastened onto the sharps container by engaging the edge of the cover with the lip of the sharps container;

FIG. 13A is a side view of yet another exemplary embodiment of apparatus for removing the cover from the disposable sharps container of FIGS. 12A and 12B, in which levers with claws are rotated by a force actuator to disengage the edge of the cover from the lip of the sharps container;

FIG. 13B is a schematic top plan view of the cover showing the exemplary apparatus of FIG. 13A positioned to remove the cover by pulling outward on the edge of the cover to disengage it from the lip of the sharps container; and

FIG. 14 is yet another exemplary embodiment apparatus that uses fixed bars or rods to push against the cover, as the claws of the apparatus are drawn upwardly, to pull on the edge of the cover and disengage the edge from the lip of the sharps container.

### DESCRIPTION

### Figures and Disclosed Embodiments are not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein. Further, it should be understood that any feature of one embodiment disclosed herein can be combined with one or more features of any other embodiment that is disclosed, unless otherwise indicated.

### Exemplary Sharps Container

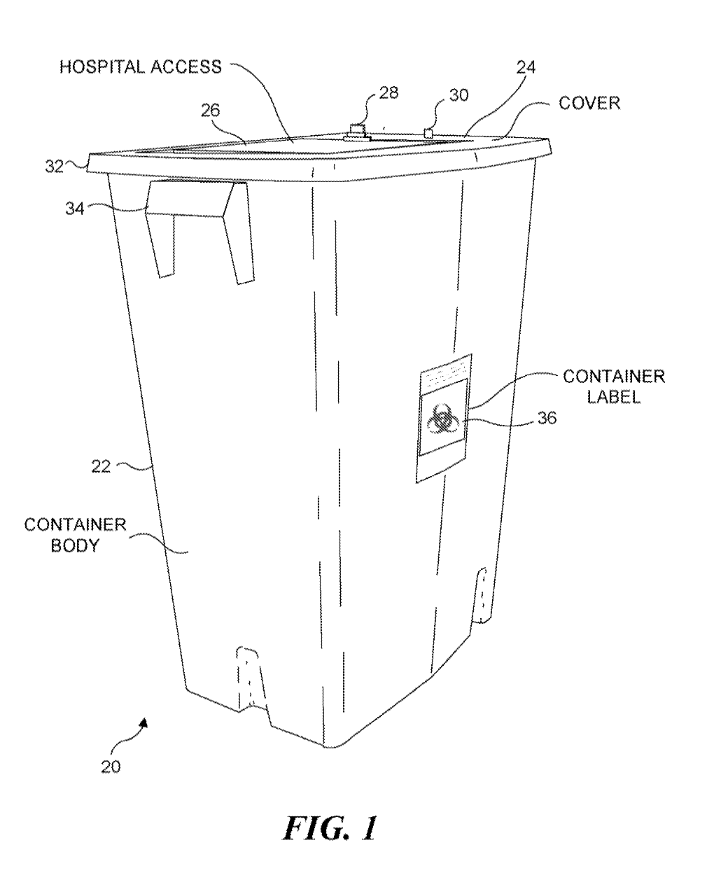

FIGS. 1-6 illustrate details of an exemplary disposable sharps container 20 used for collecting used medical instruments and medical waste in hospitals, and other facilities. Sharps container 20 includes a container body 22 that defines the collection volume for holding the discarded medical waste and devices. A cover 24 is fastened onto the container body and is not intended to thereafter be removed, which is why sharps container 20 is of the disposable type. Once sharps container 20 is full and a hospital access door 26 has been placed in a locked position, the sharps container and its contents are intended to be picked up and transported to a suitable disposal facility for safe disposal of the container and its contents—without the cover ever being removed. Normally, the sharps container with its cover and contents intact are simply incinerated. However, the present approach will instead remove cover 24 from container body 22 and then access the contents of the sharps container to enable reusable medical devices to be recovered, cleaned, sterilized, and then reused. In addition, after its contents have been removed using any of the exemplary embodiments described below, sharps container 20 and cover 24 can also be cleaned, sterilized, and reused.

It will be helpful to examine the elements of exemplary disposable sharps container 20, since many of these elements are found in other disposable sharps containers, although such containers may have different shapes and sizes, and their components may operate in a slightly different manner. As shown in FIG. 1, hospital access door 26 on cover 24 includes a finger grip 28 that can be grasped by medical personnel to move the hospital access door between a temporary closed position and an open position, and when the sharps container is substantially full, to position the hospital access door in a locked position. A stop 30 limits the travel of hospital access door 26. Cover 24 is attached to container body 22 by engaging an edge 32 of the cover over a lip (not shown in FIG. 1) of the container body. Sharps container 22 may optionally include a handle 34 on opposite sides to facilitate handling the sharps container when it is necessary to move it. Biomedical waste labels 36 are adhesively attached to opposite surfaces of the sharps container to warn that the contents comprise sharps, regulated medical wastes, and biohazard materials that are potentially harmful. The user of the sharps container is thus warned that the contents comprise used medical devices and waste that may have sharp points, cutting edges, and/or be contaminated with biologically harmful pathogens and other substances.

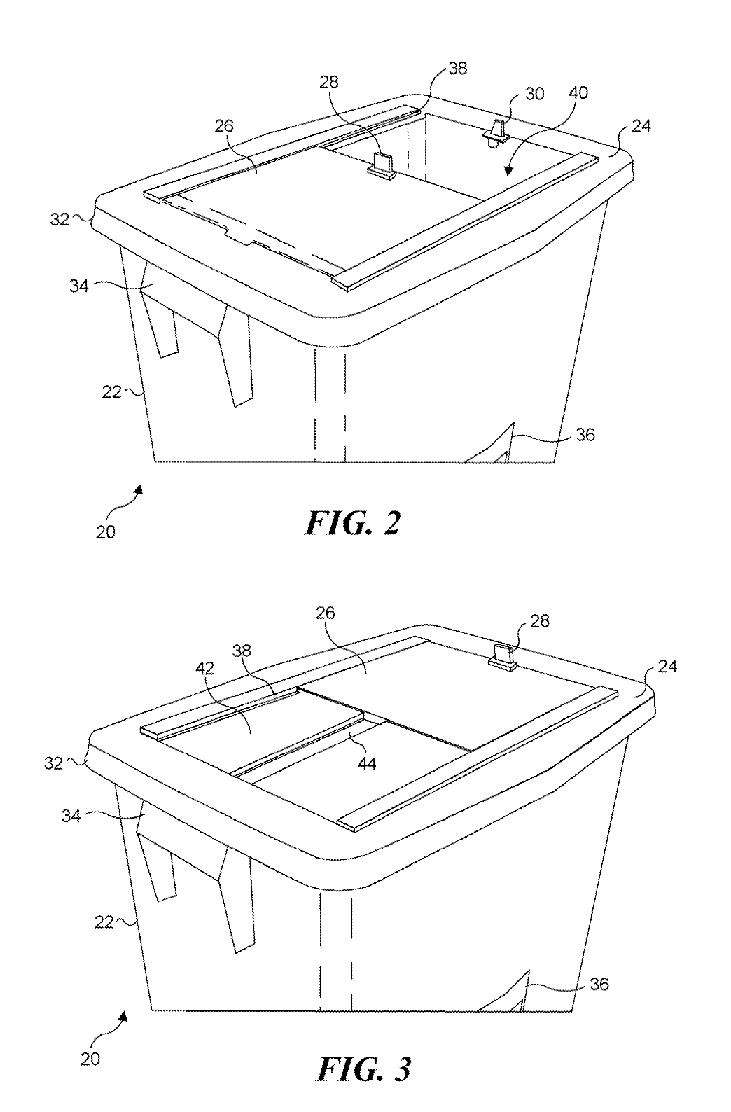

FIG. 2 illustrates hospital access door 26 in an open position, giving access to an inner volume 40, to enable medical devices and other objects to be dropped into the disposable sharps container. The hospital access door slides within slots 38 that are formed on each side of the opening into inner volume 40. In FIG. 3, hospital access door 26 is shown in a temporary closed position, with finger grip advanced into contact, but not engagement with, stop 30 (shown in FIGS. 1 and 2). Also evident in FIG. 3 is a guide slot 44 that extends longitudinally through the middle of a recessed panel 42 and is used for maintaining the hospital access door centered relative to recessed panel 42, as the hospital access door is slid within slots 38.

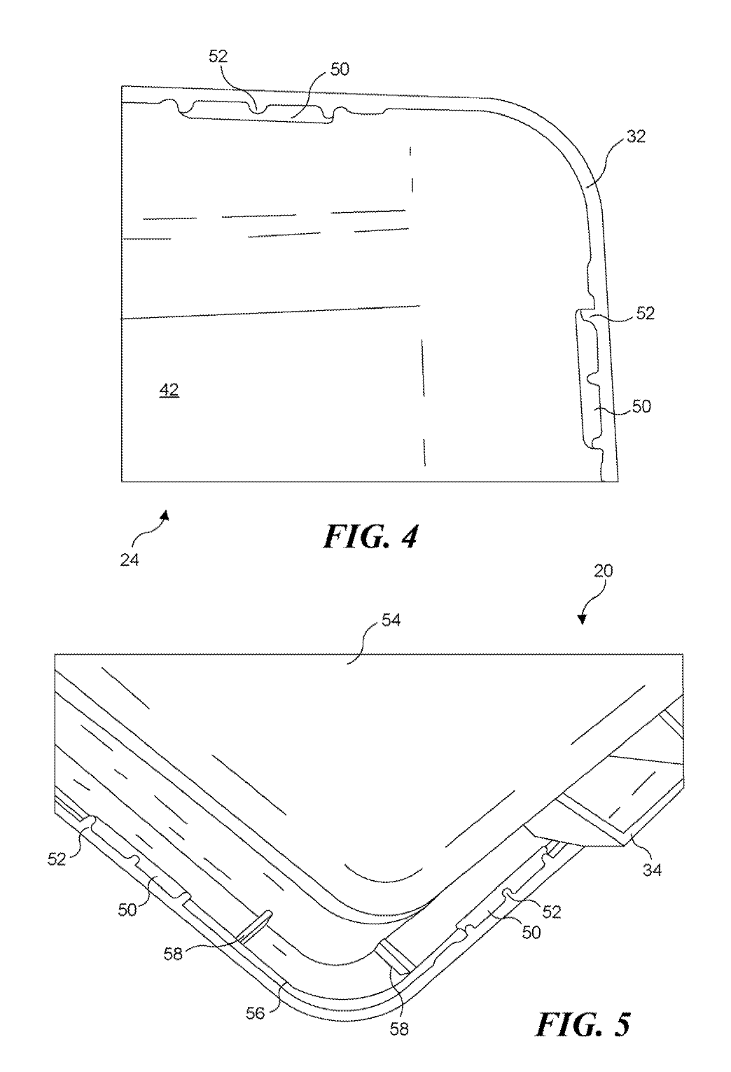

The undersurface of cover 24 is illustrated in FIG. 4. As is evident in this view, edge 32 of cover 24 includes a plurality of tabs 50 that extend inwardly from the interior surface of edge 32. Each tab 50 is stiffened by reinforcements 52 (which also extend from the lower portion of edge 32) disposed at each end and at the middle of the tab. Reinforcements 52 thus help tabs 50 to engage and more effectively grip lip 56 of container body 22, as shown in FIG. 5. Lip 56 extends around the periphery at the top of container body 22 and is reinforced and made stiffer by a plurality of spaced-apart ribs 58 that extend across the gap between the downwardly depending outer portion of lip 56 and the adjacent outer surface of container body 22.

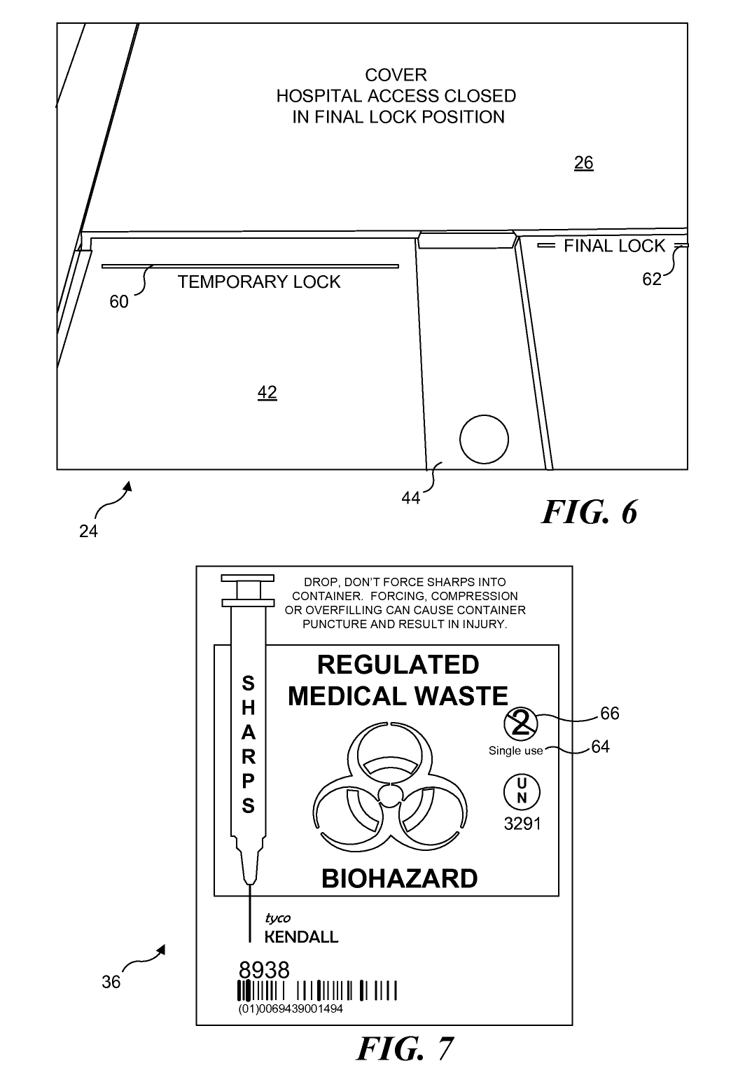

FIG. 6 illustrates a portion of cover 24, showing hospital access door 26 permanently closed to a final lock position, as indicated by raised ridge 62 and the associated raised text. Until disposable sharps container 20 is filled, hospital access door 26 is only closed to a temporary lock position, as indicated by a raised ridge 60 and the associated text. Raised ridges 60 and 62 are formed on recessed panel 42 and are labeled. When placed in the final lock position, hospital access door 26 is not readily opened, to prevent further access to the inner volume of the container body, since the disposable sharps container would then typically be collected and disposed of with its contents inside.

FIG. 7 illustrates an exemplary label 36 of the type typically used on a disposable sharps container. Note that a label 64 clearly indicates “Single use,” and a symbol 66 (which is the number “2” with a line drawn diagonally through the number) further indicates that the sharps container is only intended to be used one time—until full, and then not used again. Label 36 includes the warning about the nature of the contents of the disposable sharps container and also includes the following warning: “Drop, don't force sharps into container. Forcing, compression, or overfilling can cause container puncture and result in injury.”

Exemplary Apparatus for Removing Cover from Disposable Sharps Container

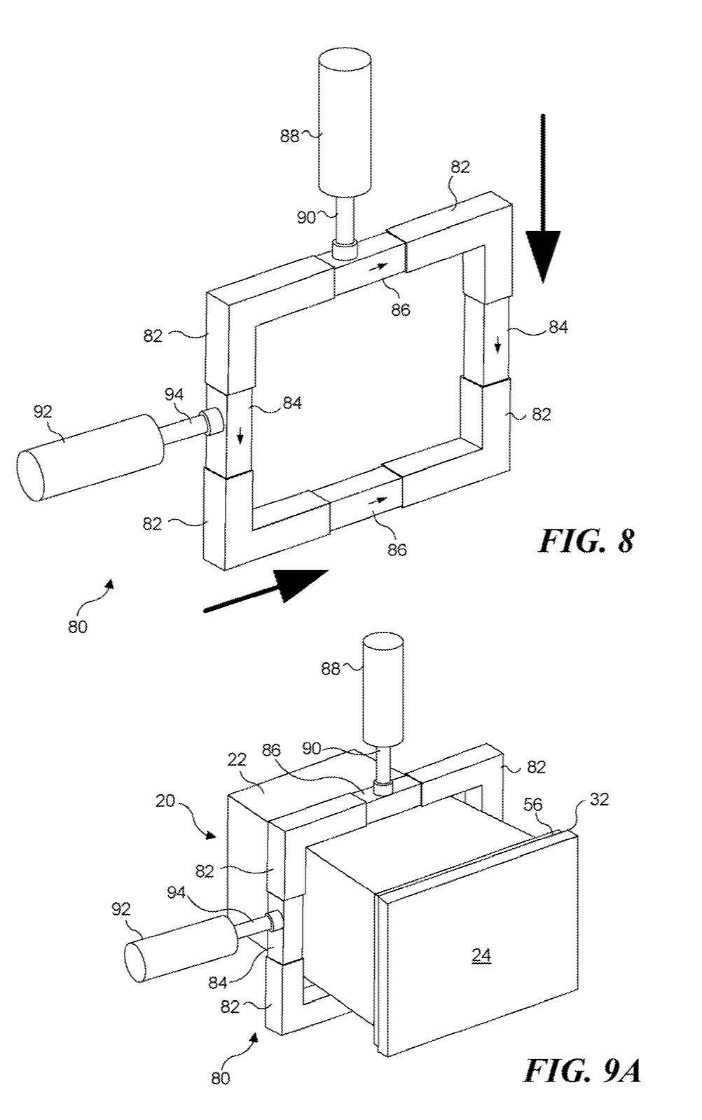

In FIG. 8, a first exemplary embodiment 80 of apparatus illustrated for removing the cover from a sharps container includes four corner sections 82 that are hollow and slide over internal end sections 84 and internal side sections 86. Alternatively, by resizing corner sections 82 to be relatively smaller in cross-sectional size and making the end and side sections relatively large in cross-sectional size and hollow, the corner sections can instead slide within the end and side sections. Corner sections 82, end sections 84, and side sections 86 together comprise a quadrilateral frame that is thus variable in length and width. Force actuator 88 can be energized to provide a force directed through a shaft 90 that moves adjacent corner sections 82 and end sections 84, causing end sections 84 to move either further into or out of the other two corner sections 82 that are further from shaft 90. Shaft 90 applies the force to one of side sections 86. As shown in FIG. 8, end sections 84 are being forced further into the other two corner sections to reduce the width of the quadrilateral frame. Similarly, a force actuator 92 produces a force that is applied through a shaft 94 to one of end sections 84, which causes the two adjacent corner sections and side sections 86 to move either further into or out of the other two corner sections that are further from shaft 94. Also as shown in FIG. 8, side sections 86 are being forced further into the other two corner sections to reduce the length of the quadrilateral frame. Force actuators 88 and 92 can be prime movers (e.g., electrical motors that move shafts 90 and 94 inwardly or outwardly from the electrical motors—depending upon the direction of rotation of the motor), or can be either pneumatic or hydraulic cylinders that use a pressurized fluid supplied by a pressure pump (not shown) to move shafts 90 and 94 either inwardly or outwardly of the force actuators. The force applied to side section 86 and end section 84 by the force actuators is used as described below, to cause the covers to be removed from the sharps containers.

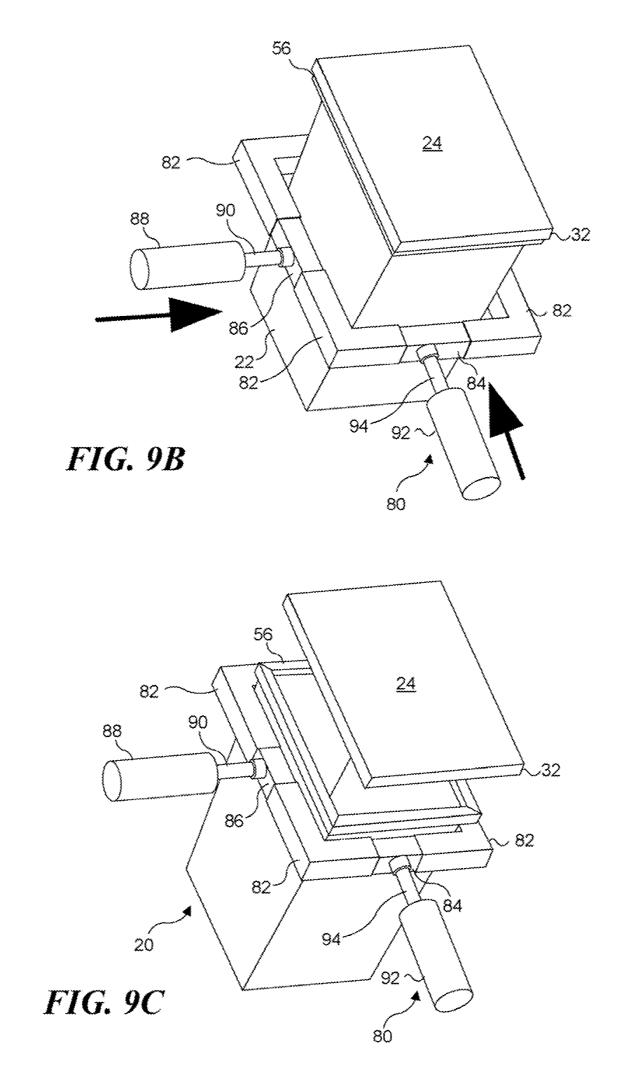

Use of exemplary embodiment 80 with disposable sharps container 20 is illustrated in FIGS. 9A-9C. Note that in these and the other Figures discussed below, details of the disposable sharps container such as hospital access door 26 and handles 34 are not shown to simplify the Figures. In FIG. 9A, embodiment 80 has been sized to readily slip around disposable sharps container 20—i.e., the length and width of the quadrilateral frame have been adjusted by force actuators 88 and 92 to be substantially greater than the dimensions of container body 22. Not shown in these Figures are the supports for the quadrilateral frame that are configured to maneuver the quadrilateral frame and attached force actuators. Such maneuvering supports are well known in the art and often employ arms that include universal joints and employ hydraulic or pneumatic cylinders to move a supported body in three dimensions. Examples of such maneuvering supports are the robotic arms used in automotive assembly lines.

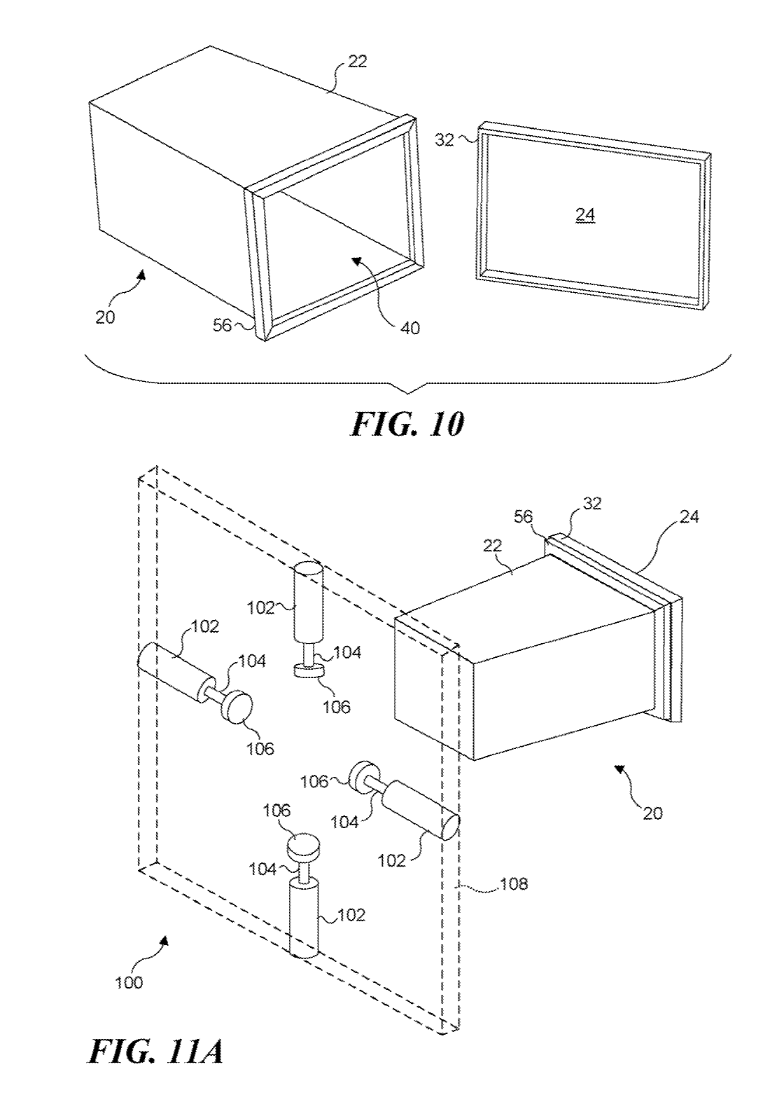

As the quadrilateral frame is moved along container body 22, the force actuators can begin adjusting the length and width of the frame to more closely match the outer dimension of the container body, as shown in FIG. 9B. Once embodiment 80 is positioned so that the quadrilateral frame is adjacent to lip 56 on container body 22, sufficient force is applied by force actuators 88 and 92 and directed through shafts 90 and 94, respectively, so that end sections 84 and side sections 86 act on the outer surface of container body 22, deflecting it inwardly and causing lip 56 to disengage edge 32 of cover 24. Cover 24 then pops free and is removed from container body 22, providing access to the contents of the disposable sharps container. Container body 22 can then be inverted to dump out the contents onto a sorting surface (not shown). Next, as shown in FIG. 10, the disposable sharps container is ready for cleaning, sterilization, and subsequent reuse—instead of being disposed of after a single use.

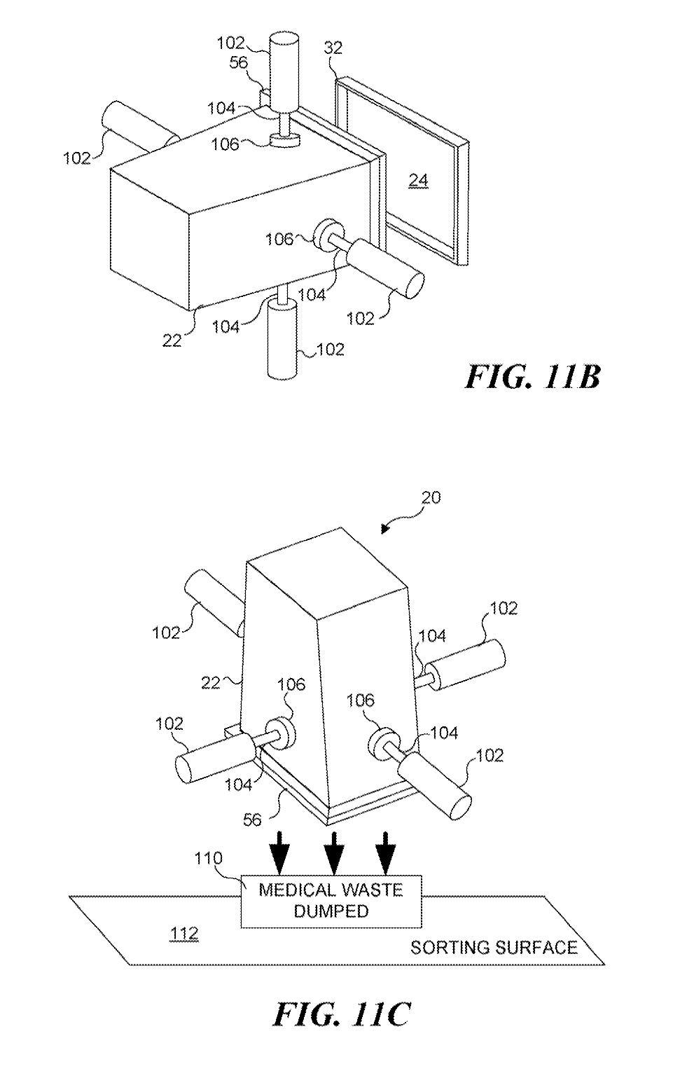

Another exemplary embodiment 100 of apparatus for removing the cover from a disposable sharps container is illustrated in FIGS. 11A-11C. In this embodiment, a plurality of force actuators 102 are supported so that each can be disposed at different sides of a disposable sharps container, such as sharps container 20. Each force actuator provides a directed force through a shaft 104. A distal end of shaft 104 is coupled to a force applicator 106, which actually applies the force to the outer surface of container body 22. The force actuators are supported, for example, in a maneuverable frame 108, which is shown in phantom view in FIG. 11A, since it represents just a simple example of the many ways to support the force actuators while they produce the force necessary to remove the cover from the sharps container. Again, force actuators 102 can comprise prime movers, such as electrical motors that rotate shaft 104 to cause it to move inwardly or outwardly along the longitudinal axis of the force actuator, depending upon the direction of the rotation of the electrical motors. Alternatively, force actuators 102 can comprise pneumatic or hydraulic cylinders with internal pistons (not shown) that are coupled to shaft 104, so that a pressurized fluid supplied by a pressure pump (not shown) moves the shaft inwardly or outward along the longitudinal axis of the force actuator. To simplify the Figures, maneuverable frame 108 is not shown in FIGS. 11B and 11C.

In FIG. 11B, force actuators 102 have advanced force applicators 106 inwardly toward the outer surface of container body 22, so that force applicators 106 each contact a different side of the disposable sharps container, at points on each side of the container and adjacent to where edge 32 of cover 24 engages lip 56 of the container body. As the force applicators apply sufficient inwardly directed force to container body 22, lip 56 is forced to disengage from edge 32 of the cover, removing the cover as shown in FIG. 11B. Next, as shown in FIG. 11C, while container body 22 is still gripped by force applicators 106, the container body is inverted to dump the medical waste 110, which may contain reusable medical devices, onto a sorting surface 112. The reusable medical devices can then be selectively retrieved from the sorting surface for cleaning, sterilization, and subsequent reuse. After the contents of the disposable sharps container have been emptied, the sharps container and its cover may also be cleaned, sterilized, and made available for reuse—just as indicated in FIG. 10 in connection with the use of exemplary embodiment 80.

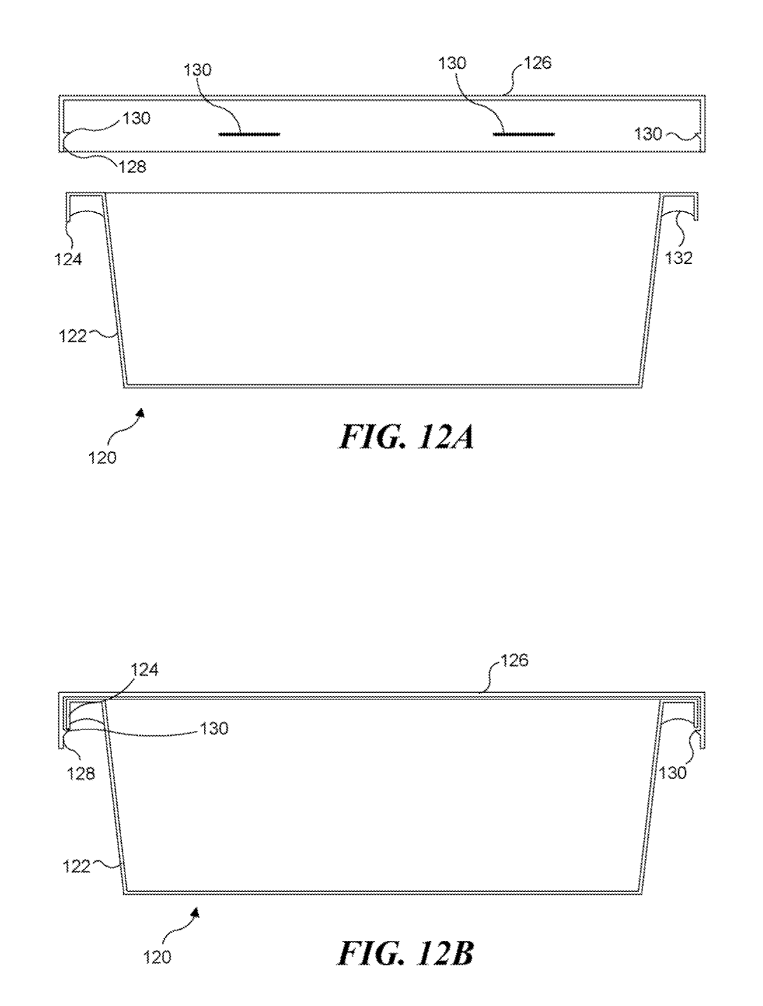

FIGS. 12A and 12B illustrate details of an exemplary disposable sharps container 120, showing how a cover 126 is configured to engage a container body 122 of the sharps container. In FIG. 12A, the cover is shown as it is being lowered onto container body 122 to be fastened in place. Cover 126 has an edge 128 that depends downwardly from the upper surface of the cover. A plurality of inwardly extending tabs 130 are disposed at spaced-apart positions around the interior surface of edge 128. Container body has a lip 124 that extends around the perimeter of the opening into the container. Ribs 132 are provided to stiffen the lip so that it is relatively rigid and does not readily flex inwardly or outwardly. When cover 126 is secured to container body 122 of disposable sharps container 120, tabs 130 snap into engagement with the lower end of lip 124, so that the edge of the cover engages the lip of the container body, retaining the cover in place. Because of the relative stiffness of the edge of the cover and the lip of the container body, a substantial force is required to disengage the edge of the cover from the lip of the container body, once the two parts have become engaged. Since the cover of a disposable sharps container is not normally intended to be removed from the container body, the design of the cover and container body is intended to resist removal of the cover—once edge 128 of the cover has engaged lip 124 on the container body.

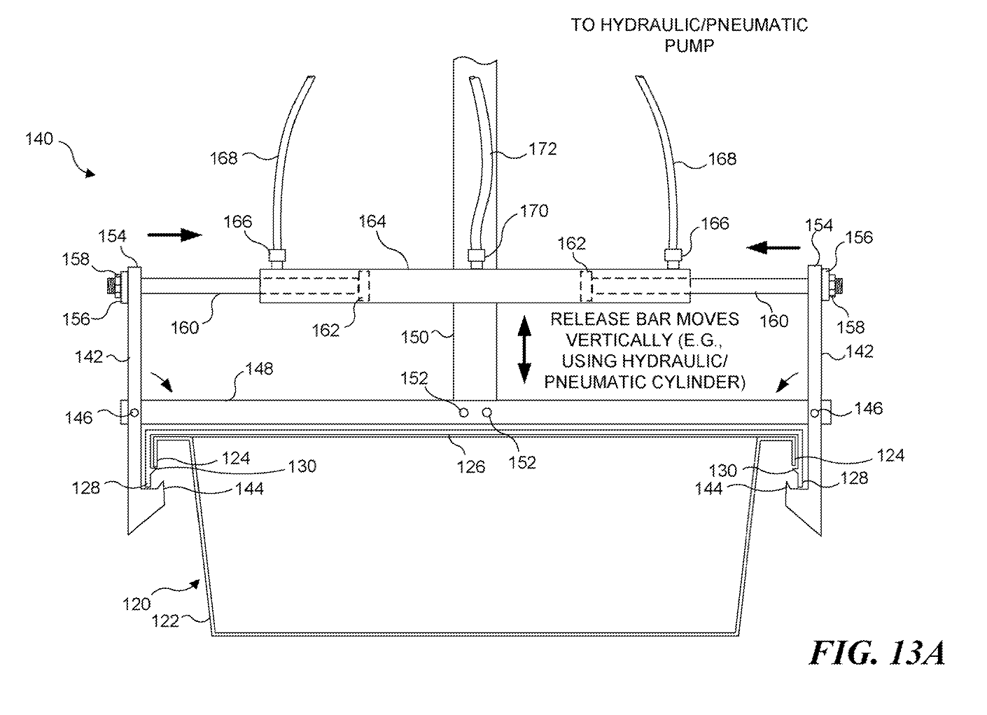

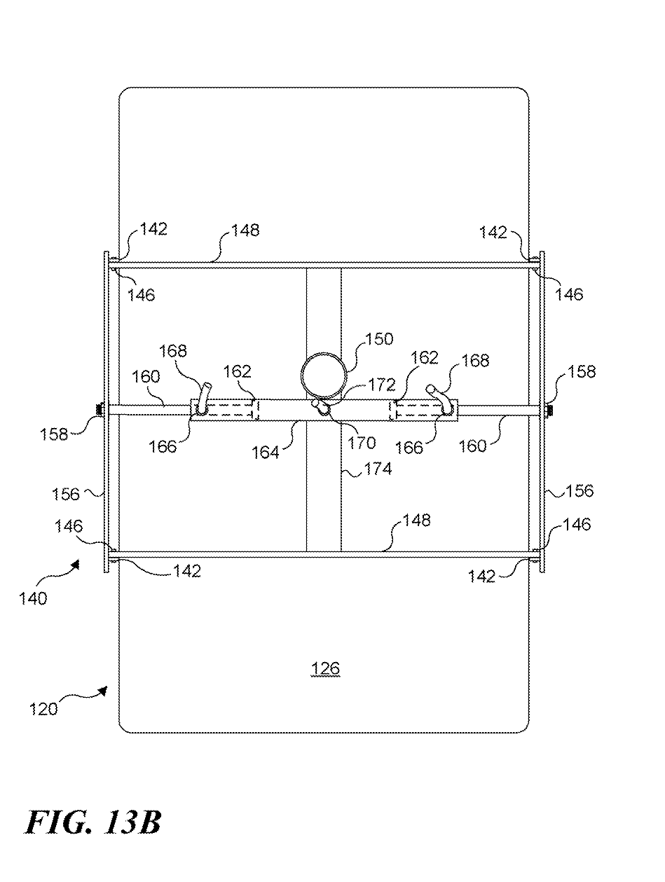

Yet another exemplary embodiment 140 of apparatus for removing a cover from a disposable sharps container is illustrated in FIGS. 13A and 13B. In this embodiment, levers 142 having inwardly facing claws 144 are disposed on each side of disposable sharps container 120, so that claws 144 can engage edge 128 when levers 142 are pivoted about a pivot pin 146 that pivotally connects levers 142 to a cross member 148 that extend above the top of cover 126. While only two levers 142 are shown in FIG. 13A, at least two more levers will be used, as indicated in FIG. 13B. The levers and claws are disposed at about the positions of tabs 130 on edge 128, so that when the lever is pivoted to move claws 144 outwardly away from the outer surface of container body 122, the claws engage edge 128 and cause the tabs on the edge to disengage from lip 124 on container body 122, removing the cover from the container body. An upper end 154 of each lever 142 is coupled to a bar 156 that extends above the edge of the cover and along that side. As shown more clearly in FIG. 13B, bar 156 is connected by threaded nut 158 to a shaft that is coupled with a piston 162 disposed inside a hydraulic or pneumatic cylinder 164. The same arrangement of rod 160 and another piston 162 inside cylinder 164 is provided at the opposite end of the cylinder. Fluid fittings 166 at each end of cylinder 164 and a fluid fitting 170 in the center of the cylinder are coupled to pressurized fluid lines 168 and 172, respectively. These pressurized fluid lines are coupled to a hydraulic/pneumatic pump (not shown) and pressurized fluid is selectively supplied to the cylinder through either pressurized fluid lines 168 or pressurized fluid line 170. When the pressurized fluid is supplied through pressurized fluid lines 168, levers 142 are pivoted to disengage tabs 130 on edge 128 from lip 124. Supplying pressurized fluid through pressurized fluid line 170 pivots the levers in the opposite direction to engage claws 144 with edge 128. As shown in FIG. 13B, a release bar 174 connects with cross members 148 using fasteners 152. Release bar 174 is also connected to a pipe 150 that can be moved vertically up or down using a prime mover, or either a hydraulic or pneumatic cylinder (not shown).

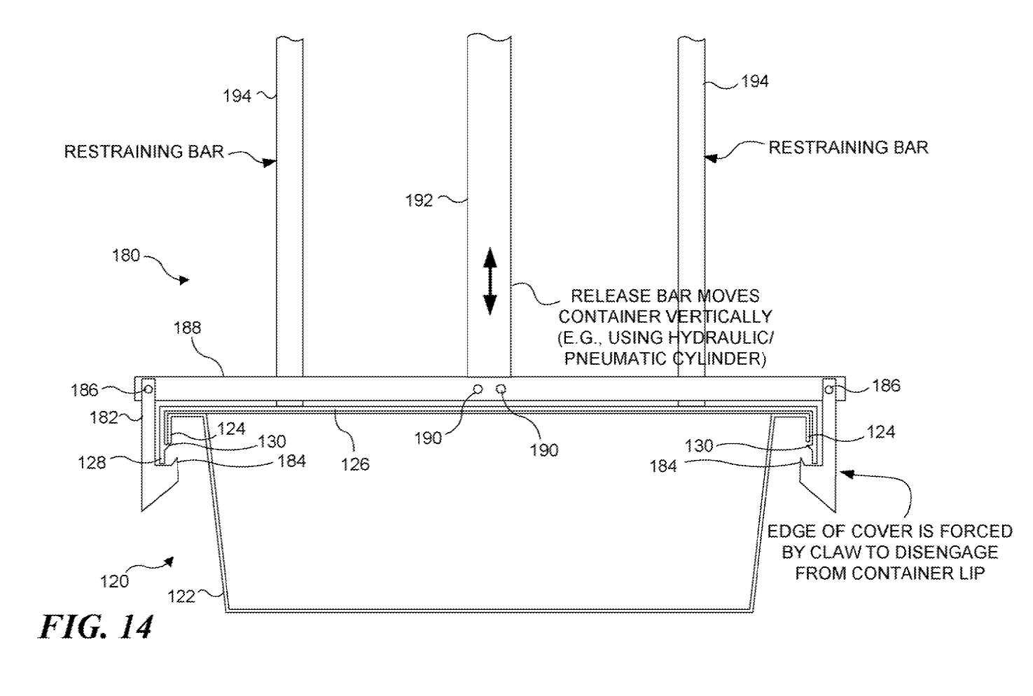

Still another exemplary embodiment 180 is illustrated in FIG. 14. In this embodiment, a more “brute force” approach is used for disengaging tabs 130 on edge 128 of the cover from lip 124 of the container body of disposable sharps container 120. Levers 182, each having a claw 184 formed on their lower end, are pivotally coupled by a pivot pin 186 to a crossbar 188 that extends over the top of cover 126. Another lever 182 is similarly pivotally attached to the opposite end of crossbar 188 and engages edge 128 on the other side of cover 126. Claws 184 extend inwardly of the edge of the cover. Crossbar 188 is coupled by fasteners 190 to a release bar 192 that is moved by a prime mover (not shown), e.g., an electrical motor, or a hydraulic/pneumatic cylinder with a piston actuated by a supply of a pressurized fluid. Release bar 192 is thus selectively moved vertically downward (for the orientation shown in FIG. 14) to first cause claws 184 to engage edge 128 of the cover. Next, release bar 192 is selectively moved upwardly (again—relative to the orientation shown in FIG. 14), causing the claws to apply a force on edge 128 that disengages it from lip 124. To prevent disposable sharps container 120 from simply being lifted by claws 184 when release bar 192 is urged upwardly, one or more restraining bars 194 contact the top surface of cover 126. The upward force applied to claws 184 in opposition to the restraining force of restraining bars 194 thus tends to bend the sides of cover 126 upwardly, until tabs 130 on edge 128 disengage from lip 124. Restraining bars 194 can then be moved upwardly to enable the cover to be moved out of the way while container body 122 is picked up by claws 184 and tilted to dump its contents (medical waste objects) onto a sorting surface (not shown in this Figure), to enable reusable medical devices to be sorted from the waste, cleaned, sterilized, and then reused. Similarly, cover 126 and container body 122 can also be cleaned, sterilized, and reused.

The above discussion has focused on the use of several exemplary embodiments of apparatus for removing the cover from disposable sharps containers. However, it will be evident that these exemplary embodiments can also be used to automate the process for removing the covers from reusable sharps containers. In the claims that follow, the phrase “means for disengaging an edge on the cover from a lip on the sharps container and removing the cover from the sharps container to expose the contents of the sharps container” is used. It will be apparent that this phrase applies to components of exemplary embodiment 80 (shown in FIGS. 8, and 9A-9C), exemplary embodiment 100 (shown in FIGS. 11A-11C), exemplary embodiment 140 (shown in FIGS. 13A and 13B), and exemplary embodiment 180 (shown in FIG. 14), as well as equivalents of each exemplary embodiment. Similarly, the components of each of these exemplary embodiments and equivalents thereof also correspond to “means for handling the sharps container to access its contents,” as recited in the claims that follow, as should be evident from the above discussion.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. Apparatus for use in removing a cover from a medical waste sharps container, to access contents of the sharps container, comprising:
(a) means for disengaging an edge on the cover from a lip on the sharps container and removing the cover from the sharps container to expose the contents of the sharps container; and
(b) means for handling the sharps container to access its contents.

2. The apparatus of claim 1, wherein the means for disengaging the edge on the cover comprises a plurality of force actuators disposed to selectively apply an inwardly directed force against the surface of the sharps container, at opposite sides of the sharps container and at positions that are adjacent to the lip on the sharps container, wherein the force displaces the lip inwardly so that it disengages from the edge of the cover, thereby releasing the cover from the sharps container.

3. The apparatus of claim 1, wherein the means for disengaging the edge on the cover comprises a variable dimension frame that encompasses the sharps container, the variable dimension frame including:
(a) two sides, each side having a variable length;
(b) two ends coupled to the two sides, each end having a variable length; and
(c) a plurality of force actuators that apply force to the variable dimension frame to change the lengths of the sides and the ends of the variable dimension frame, wherein a dimension of the variable dimension frame is changed by the plurality of force actuators causing the sides and ends to apply force to the outer surface of the sharps container at positions adjacent to the lip on the sharps container, the force displacing the lip inwardly, disengaging the lip from the edge of the cover, and thereby releasing the cover from the sharps container.

4. The apparatus of claim 1, wherein the means for disengaging the edge on the cover comprises a plurality of levers, each lever having a claw for engaging a portion of the edge of the cover and applying force outwardly, disengaging the edge of the cover from the lip of the sharps container, and thereby releasing the cover from the sharps container.

5. The apparatus of claim 4, wherein the means for disengaging further comprise at least one post that presses down on the cover while claws on the plurality of levers pull on the edge of the cover, so that the cover deflects and the edge of the cover is forced to disengage from the lip of the sharps container.

6. The apparatus of claim 4, wherein the means for disengaging further comprise at least one force actuator mechanically coupled to the plurality of levers for producing the force that causes the claws on the plurality of levers to disengage the edge of the cover from the lip of the sharps container and selected from the group consisting of:
(a) a cylinder having a piston actuated to move within the cylinder with a pressurized fluid that is supplied to the cylinder; and
(b) a prime mover.

7. The apparatus of claim 1, wherein the means for handling the sharps container is operative to tilt the sharps container after the cover has been removed, and to dump the contents of the sharps container onto a sorting surface.

8. A method for removing the lid from a medical waste sharps container, to access contents of the sharps container, comprising the steps of:
(a) using automated apparatus for applying a mechanical force at multiple points where an edge of the cover engages a lip of the sharps container, the mechanical force causing the edge of the cover to disengage the lip of the sharps container;
(b) removing the cover from the sharps container once the edge of the cover has disengaged from the lip of the sharps container; and
(c) accessing the contents of the sharps container after the cover has been removed from it.

9. The method of claim 8, wherein the step of applying the mechanical force comprises the steps of:
(a) positioning force actuators adjacent to a surface of the sharps container, at opposite sides of the sharps container, and at positions that are adjacent to the lip on the sharps container; and
(b) energizing the force actuators to selectively apply an inwardly directed force with the force actuators to the positions, sufficient to displace the lip of the sharps container inwardly so that it disengages from the edge of the cover, thereby releasing the cover from the sharps container.

10. The method of claim 9, wherein the step of accessing the contents of the sharps container comprises the steps of:
(a) gripping the sharps container with the force actuators; and
(b) reorienting the sharps container with the force actuators, to dump the contents of the sharps container on a sorting surface.

11. The method of claim 8, wherein the step of applying the mechanical force comprises the steps of:
(a) positioning a variable dimension frame having two sides and two ends, so that the variable dimension frame encompasses the sharps container and is disposed adjacent to sides of the sharps container and proximate to the edge of the cover, wherein a length of each side and each end of the variable dimensional frame is selectively adjustable; and
(b) using force actuators, changing a length of the sides and of the ends of the variable dimension frame, so that the variable dimension frame applies an inwardly directed force against the sides of the sharps container, sufficient to disengage the edge of the cover from the lip of the sharps container, thereby releasing the cover from the sharps container.

12. The method of claim 11, wherein the step of accessing the contents of the sharps container comprises the steps of:
(a) gripping the sharps container with the variable dimension frame; and
(b) reorienting the sharps container using the variable dimension frame, to dump the contents of the sharps container on a sorting surface.

13. The method of claim 8, wherein the step of applying the mechanical force comprises the steps of:
(a) engaging the edge of the cover at a plurality of spaced-apart locations with each of a plurality of mechanical claws; and
(b) in an automated manner, applying a force on the edge of the cover sufficient to disengage the edge of the cover from the lip of the sharps container, thereby releasing the cover from the sharps container.

14. The method of claim 13, wherein the step of applying the mechanical force further comprises the step of applying a force that presses down on an upper surface of the cover while the mechanical claws pull on the edge of the cover, so that the cover deflects and the edge of the cover is forced to disengage from the lip of the sharps container.

15. The method of claim 13, wherein the step of applying the mechanical force further comprises the step of employing a force actuator to produce the force that causes the claws to disengage the edge of the cover from the lip of the sharps container, the force actuator being selected from the group consisting of:
(a) a cylinder having a piston that is mechanically coupled to the claws and moved within the cylinder in response to a pressurized fluid supplied to the cylinder; and
(b) a prime mover that is mechanically coupled to the claws.

16. The method of claim 8, further comprising the step of tilting the sharps container after the cover has been removed, and wherein the step of accessing the contents of the sharps container comprises the step of dumping the contents of the sharps container onto a sorting surface.

17. The method of claim 8, further comprising the step of recovering the sharps container and the cover for cleaning and sterilizing, to enable the sharps container and the cover to be reused for collecting medical waste and devices.

18. Apparatus for use in removing a cover from a medical waste sharps container that has been closed for disposal of the sharps container and its contents, to enable recovery of reusable medical devices that may be included in the contents, comprising:
(a) at least one force actuator that can be selectively energized to produce a directed force; and
(b) a plurality of force applicators that are mechanically coupled to the at least one force actuator and are positionable in response to the directed force provided by the at least one force actuator to apply a force either to an outer surface of the sharps container or to the edge of the cover, at positions disposed adjacent to where an edge of the cover engages a lip of the sharps container, the force applied by the plurality of force applicators being sufficient to disengage the edge of the cover from the lip of the sharps container, to enable the contents of the sharps container to be accessed.

19. The apparatus of claim 18, wherein the force actuator is selected from the group consisting of:
(a) a cylinder having a piston and supplied with a pressurized fluid to move the piston within the cylinder; and
(b) a prime mover that is selectively energized to move the plurality of force applicators.

20. The apparatus of claim 18, wherein the plurality of force applicators comprise sections of a quadrilateral frame that are adjustable to vary a length and a width of the frame, the quadrilateral frame being adjustable to be sufficiently large to be slipped around a sharps container and positioned adjacent to the edge of the cover, the at least one force actuator comprising a plurality of force actuators that move the slidable sections of the quadrilateral frame so that sections tighten around the sharps container and apply the force to the outer surface of the sharps container that causes the lip of the sharps container to disengage from the edge of the cover, removing the cover.

21. The apparatus of claim 18, wherein the at least one force actuator comprises a plurality of force actuators, each of which is coupled to a different one of the plurality of force applicators, and wherein each force applicator comprises a pad that applies force against a different side of the outer surface of the sharps containers, adjacent to where the edge of the cover engages the lip of the sharps container, so that the force is directed inwardly and causes the lip of the sharps container to disengage from the edge of the cover, removing the cover.

22. The apparatus of claim 18, wherein the plurality of force applicators comprises claws that are mechanically coupled to the at least one force actuator and engage the edge of the cover at spaced-apart positions, so that when the force is applied by the at least one force actuator, the claws pull the edge of the cover, disengaging the edge from the lip of the sharps container, and removing the cover.

23. The apparatus of claim 18, wherein the plurality of force applicators comprises a plurality of levers having claws disposed at one end, the other end of each lever being mechanically coupled to the at least one force actuator and the levers being spaced apart to engage the edge of the cover at disparate points, so that when the at least one force actuator is activated, the force applied to the levers causes the claws to disengage the edge of the cover from the lip of the sharps container, removing the cover.

24. The apparatus of claim 8, wherein the plurality of force applicators are configured to grip the sharps container to enable the sharps container to be moved about and reoriented, so that when the cover has been removed, the plurality of force applicators tilt the sharps container to dump its contents onto a sorting surface.

25. The apparatus of claim 24, wherein after removing the cover from the sharps container and dumping its contents, the plurality of force applicators are configured to grip the sharps container and move it so as to enable the sharps container to be recovered and recycled for reuse.

26. The apparatus of claim 24, further comprising at least one restraint applicator that applies a restraining force downwardly against a top of the cover while the plurality of force applicators pull upwardly on the edge of the cover, causing the cover to bend, and the edge of the cover to disengage from the lip of the sharps container.
